(19) United States
(12) Patent Application Publication
(10) Pub. No.: US 2011/0253479 A1
(43) Pub. Date: Oct. 20, 2011

(54) LADDER STABILIZING APPARATUS

(76) Inventor: Ronald Gandy, Grants Pass, OR (US)

(21) Appl. No.: 12/914,642

(22) Filed: Oct. 28, 2010

Related U.S. Application Data
(60) Provisional application No. 61/324,020, filed on Apr. 14, 2010.

(51) Int. Cl. E06C 7/18

(52) U.S. Cl. 182/107

(57) ABSTRACT

A ladder stabilizing device may attach a ladder, such as an extension ladder, to a structure, such as a house gutter or a fascia board of a new or existing home. The ladder stabilizing device may prevent the ladder from slipping, tilting or tipping.

### CROSS-REFERENCE TO RELATED APPLICATIONS

This application claims the benefit of priority to U.S. Provisional patent application No. 61/324,020, filed Apr. 14, 2010, which is herein incorporated by reference.

### BACKGROUND OF THE INVENTION

The present invention relates to a ladder stabilizing apparatus and, more particularly, to a device that attaches a ladder to a gutter and/or a fascia board of an existing or new home.

One current ladder stabilizing device includes arms that may extend from the sides of a ladder to provide the ladder with a wider base to contact the structure. These devices, however may allow the ladder to tilt either to the side or away from the structure. Another current device attaches to the ladder by means of a spring loaded clamp. This device only attaches to one side of the ladder and may allow the ladder to tilt one side off of the building. This device may also be pushed hard enough to detach the clamp as it is only spring loaded. These conventional devices may still cause a dangerous situation.

As can be seen, there is a need for a ladder stabilizing device that may not only stabilize the ladder, but may secure the ladder to a structure.

### SUMMARY OF THE INVENTION

In one aspect of the present invention, a ladder stabilizing device comprises a ladder engaging member adapted to engage rails of a ladder; and a strap piece adapted to attach to a structure, wherein the strap piece has a flat elongated portion connected to the ladder engaging member, a twist, and an attachment member adapted to connect the strap piece to a structure.

In another aspect of the present invention, a ladder stabilizing device comprises a ladder engaging member adapted to engage rails of a ladder; a strap piece adapted to attach to a structure, wherein the strap piece has a flat elongated portion connected to the ladder engaging member, a twist, and an attachment member adapted to connect the strap piece to a structure; a slot disposed in the flat elongated portion of the strap piece; and at least two holes disposed in the ladder engaging member; wherein the holes align with the slot and a bolt is disposed through the holes and the slot to provide adjustable attachment between the ladder engaging member and the strap piece.

These and other features, aspects and advantages of the present invention will become better understood with reference to the following drawings, description and claims.

### BRIEF DESCRIPTION OF THE DRAWINGS

FIG. 1 is a perspective view of a ladder stabilizing device, in use on a ladder, according to an exemplary embodiment of the present invention;

FIG. 2 is an exploded view of the ladder stabilizing device of FIG. 1;

FIG. 3 is a top view of the ladder stabilizing device of FIG. 1;

FIG. 4 is a side view of the ladder stabilizing device of FIG. 1; and

FIG. 5 is a rear view of the ladder stabilizing device of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a ladder stabilizing device that may attach a ladder, such as an extension ladder, to a house gutter or a fascia board of a new or existing home. The ladder stabilizing device may prevent the ladder from slipping, tilting or tipping.

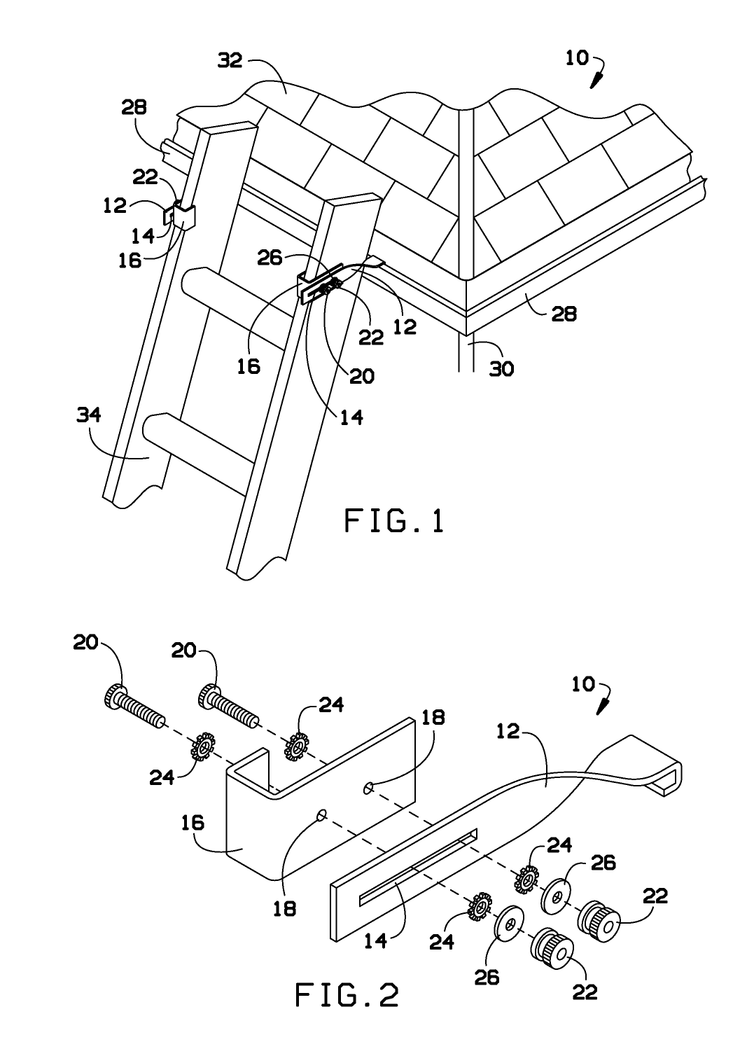

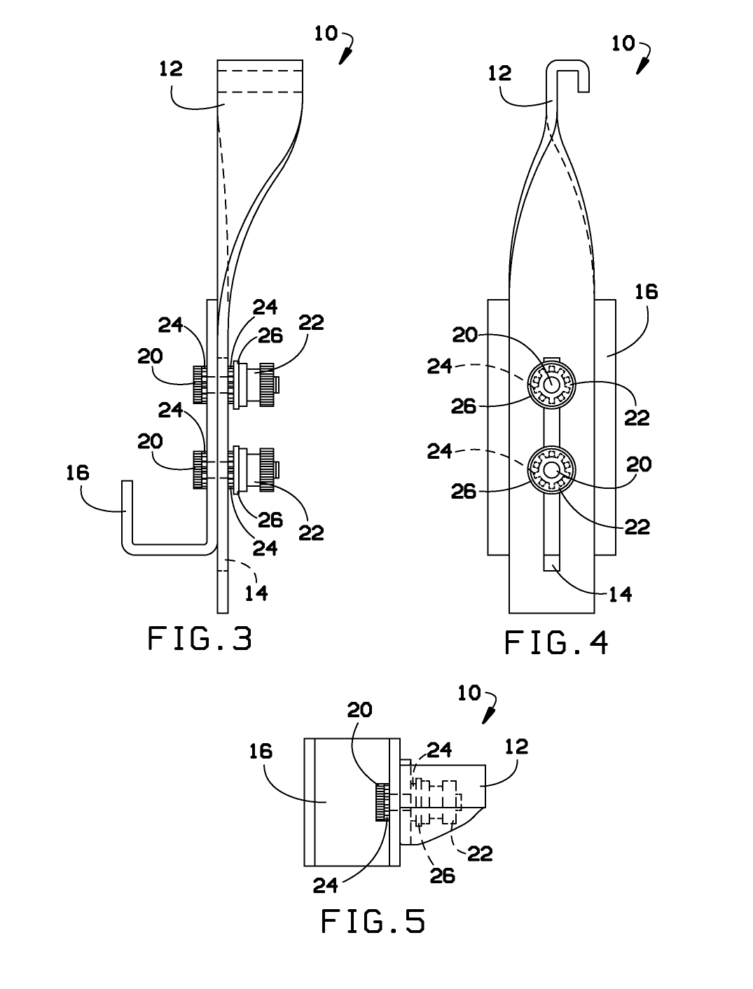

Referring to FIGS. 1 through 5, a ladder stabilizing device 10 may include a strap piece 12, adapted to attach to part of a house 30, and a ladder engaging member 16, adapted to engage a portion of a ladder 34. A slot 14 may be disposed lengthwise in the strap piece 12. At least two attachment holes 18 may be disposed in the ladder engaging member 16. Bolts, such as knurled bolts 20 may fit through the attachment holes 18 and into the slot 18. Nuts, such as knurled nuts 22 may secure the strap piece 12 to the ladder engaging member 16. Star washers 24 and flat washers 26 may be used, as is known in the art, on the knurled bolts 20.

The ladder engaging member 16 may be shaped as a squared-J, for example, with the space between the sides of the ladder engaging member 16 adapted to fit into the rails of the ladder 34. Other shapes for the ladder engaging member 16 may be used, so long as there is an opening for the ladder engaging member 16 to engage the ladder 34. For example, the ladder engaging member may be U-shaped.

The strap piece 12 may have a flat elongated portion with the slot 18 formed lengthwise in the flat elongated portion. The strap piece 12 may further include a twist, typically about a 90 degree twist having an attachment member formed on the end thereof. The attachment member, twist and elongated portion may be integrally formed as the strap piece 12. The attachment member on the strap piece 12 may be designed to attach, for example, to an upper edge of a gutter 28 positioned along a roof 32 of the house 30. The attachment member of the strap piece 12 may be, for example, J-shaped or U-shaped. Other shaped may be used, depending on the intended use. For example, the attachment member of the strap piece 12 may be made larger to attach to a window sill and secure the ladder 34 to the window sill. The twist in the strap piece 12 may turn the strap piece 12 from an alignment perpendicular to the ground to an alignment parallel to the ground, as shown in the Figures. While FIG. 1 shows the flat elongated portion of the strap piece 12 extending beyond the ladder engaging member 16, the device 10 may be designed so that the strap piece 12 does not extend beyond the ladder engaging member 16. This configuration may prevent a person or an object from getting caught on any protrusion of the flat elongated portion of the strap piece 12.

In an exemplary embodiment, the device 10 may be made from a ¾ inch aluminum strap by about ⅛ inch thick, with one end bent over ¼ inch twice to form a C-shape. The overall length of this piece may be from about 5 to about 10 inches, typically about 6 inches. This piece may be twisted 90 degrees about 5¾ inches from the end opposite of the C-shaped end. From this end, a 11/64 inch slot may be punched out from about ¼ inch from the end, extending about 5¼ inches. This will form the strap piece 12. The ladder engaging member 16 may be formed of 1½ inch wide aluminum strap by about ⅛ inch thick, 3½ inches long, bent about 90 degrees at the 3 inch mark and bent about 90 degrees at the 1½ inch mark to form a C-shape. At about ¼ inch and about 1¼ inches from the unbent end, a 11/64 inch hole may be drilled.

To use the device 10, the pieces may be joined together by the knurled bolts 20, for example, 8-32 by ¾ inch knurled bolts and #8 knurled nuts. Washers, such as flat and star washers, may be used on the bolts. The device 10 may be attached to a gutter and a ladder, the pieces squeezed together and the nuts tightened. The ladder may now be attached to the gutter and may not slip, tilt or tip.

It should be understood, of course, that the foregoing relates to exemplary embodiments of the invention and that modifications may be made without departing from the spirit and scope of the invention as set forth in the following claims.

What is claimed is:

1. A ladder stabilizing device comprising:
a ladder engaging member adapted to engage rails of a ladder; and
a strap piece adapted to attach to a structure, wherein the strap piece has a flat elongated portion connected to the ladder engaging member, a twist, and an attachment member adapted to connect the strap piece to a structure.

2. The ladder stabilizing device of claim 1, further comprising:
a slot disposed in the flat elongated portion of the strap piece;
at least two holes disposed in the ladder engaging member;
wherein the holes align with the slot and a bolt is disposed through the holes and the slot to provide adjustable attachment between the ladder engaging member and the strap piece.

3. The ladder stabilizing device of claim 1, wherein the ladder engaging member has a squared J-shaped.

4. The ladder stabilizing device of claim 3, wherein an opening formed from the squared J-shaped ladder engaging member is adapted to fit over a rail of the ladder.

5. The ladder stabilizing device of claim 1, wherein the attachment member of the strap piece is adapted to attach to a top edge of a gutter.

6. The ladder stabilizing device of claim 1, wherein the ladder stabilizing device is formed from aluminum.

7. The ladder stabilizing device of claim 1, wherein:
the ladder stabilizing device includes first and second ladder engaging members and first and second strap pieces;
the first ladder engaging member and the first strap piece attached together and adapted to secure a first rail of the ladder to the structure; and
the second ladder engaging member and the second strap piece attached together and adapted to secure a second rail of the ladder to the structure.

8. The ladder stabilizing device of claim 1, wherein the structure is a gutter.

9. A ladder stabilizing device comprising:
a ladder engaging member adapted to engage rails of a ladder;
a strap piece adapted to attach to a structure, wherein the strap piece has a flat elongated portion connected to the ladder engaging member, a twist, and an attachment member adapted to connect the strap piece to a structure;
a slot disposed in the flat elongated portion of the strap piece; and
at least two holes disposed in the ladder engaging member;
wherein the holes align with the slot and a bolt is disposed through the holes and the slot to provide adjustable attachment between the ladder engaging member and the strap piece.

10. The ladder stabilizing device of claim 9, wherein:
the ladder engaging member has a squared J-shaped; and
an opening formed from the squared J-shaped ladder engaging member is adapted to fit over a rail of the ladder.
